(19) United States
(12) Patent Application Publication
(10) Pub. No.: US 2025/0105549 A1
(43) Pub. Date: Mar. 27, 2025

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Shinji NOZAKI, Mie (JP); Daisuke SAITO, Mie (JP)

(21) Appl. No.: 18/730,803

(22) PCT Filed: Dec. 21, 2022
(86) PCT No.: PCT/JP2022/047059

§ 371 Date: Jul. 22, 2024

(30) Foreign Application Priority Data
Jan. 28, 2022 (JP) 2022-011589

(51) Int. Cl. H01R 13/518

(52) U.S. Cl. CPC H01R 13/518

(57) ABSTRACT

A connector (10) includes a housing (11). The housing (11) includes a flat first surface (41) formed on an outer peripheral surface of the housing (11), a pair of wall surface portions (43) rising from both end parts in a width direction of the first surface (41), a pair of projecting portions (44) projecting inward in the width direction from rising end parts of the pair of wall surface portions (43) and second surfaces (42) formed on the outer peripheral surface of the housing (11) and extending toward sides opposite to the projecting portions (44) from the pair of wall surface portions (43). The second surface (42) is arranged at a position higher than the first surface (41).

### TECHNICAL FIELD

The present disclosure relates to a connector.

### BACKGROUND

A bracket fitting is mounted on a housing of a connector disclosed in Patent Document 1. Receiving frames having a T-shaped cross-section are formed in two rows on a base of the housing. The bracket fitting is configured such that a main insertion piece to be inserted between the two receiving frames and sub insertion pieces on both sides of the main insertion piece are arranged in parallel into a fork shape. The two receiving frames are pushed in between the main insertion piece and the sub insertion pieces in the bracket fitting. In this way, the bracket fitting is mounted on the housing. Further, L-shaped receiving frames are also described as a conventional example in FIG. 4 of Patent Document 1.

### PRIOR ART DOCUMENT

### Patent Document

Patent Document 1: JP 2003-157935 A

### SUMMARY OF THE INVENTION

### Problems to be Solved

Regardless of the T-shaped or L-shaped receiving frame described above, if an external force such as vibration or a prying force is applied to the receiving frame, a wall surface portion rising from the base, out of the receiving frame, may be deformed.

Accordingly, the present disclosure provides a technique capable of suppressing the deformation of a wall surface portion constituting a receiving frame in a connector.

### Means to Solve the Problem

The present disclosure is directed to a connector with a housing, the housing including a flat first surface formed on an outer peripheral surface of the housing, a pair of wall surface portions rising from both end parts in a width direction of the first surface, a pair of projecting portions projecting inward in the width direction from rising end parts of the pair of wall surface portions, and second surfaces formed on the outer peripheral surface, the second surfaces extending toward sides opposite to the projecting portions from the pair of wall surface portions, the second surface being arranged at a position higher than the first surface.

### Effect of the Invention

According to the present disclosure, it is possible to suppress the deformation of a wall surface portion constituting a receiving frame in a connector.

### BRIEF DESCRIPTION OF THE DRAWINGS

FIG. 1 is a perspective view of a connector when viewed obliquely from behind.

FIG. 2 is a back view of an upper part of the connector.

FIG. 3 is a section along A-A of FIG. 2.

FIG. 4 is a section along B-B of FIG. 2.

FIG. 5 is a plan view showing a state where a mating connector is connected to the connector and a bracket is mounted.

### DETAILED DESCRIPTION TO EXECUTE THE INVENTION

### Description of Embodiments of Present Disclosure

First, embodiments of the present disclosure are listed and described.
(1) The connector of the present disclosure is provided with a housing, the housing including a flat first surface formed on an outer peripheral surface of the housing, a pair of wall surface portions rising from both end parts in a width direction of the first surface, a pair of projecting portions projecting inward in the width direction from rising end parts of the pair of wall surface portions, and second surfaces formed on the outer peripheral surface, the second surfaces extending toward sides opposite to the projecting portions from the pair of wall surface portions, the second surface being arranged at a position higher than the first surface.

In the above connector, a receiving frame is constituted by the pair of wall surface portions and the pair of projecting portions. The second surfaces extend toward the sides opposite to the projecting portions from the pair of wall surface portions, and the second surfaces are arranged at the positions higher than the first surface. According to this configuration, since the wall surface portion is reinforced as compared to a configuration in which the second surface is arranged at the same height position as the first surface, the deformation of the wall surface portion when an external force is applied to the wall surface portion can be suppressed.
(2) Preferably, the second surface is arranged at a position lower than a rising end edge of the wall surface portion.

According to this configuration, sinks are less likely to be formed in the second surface as compared to a configuration in which the second surface is arranged at the same height position as the rising end edge of the wall surface portion.
(3) Preferably, the projecting portion has a facing surface facing the first surface, and the second surface is arranged at the same height position as the facing surface or at a position higher than the facing surface.

According to this configuration, the wall surface portion can be entirely reinforced in a rising direction at a position lower than the projecting portion.
(4) Preferably, a width between an inner side surface and an outer side surface in the width direction of the wall surface portion is larger than a difference between the height position of the rising end edge of the wall surface portion and that of the second surface.

According to this configuration, since a moment generated when the rising end side of the wall surface portion receives an external force acting outward in the width direction can be reduced, the deformation of the rising end side of the wall surface portion can be suppressed.
(5) Preferably, the outer side surface in the width direction of the wall surface portion is connected to the second surface via a curved surface.

According to this configuration, since stress applied to a base end side of the wall surface portion can be dispersed by the curved surface when the rising end side of the wall surface portion is deflected and deformed outward in the width direction, the deformation of the wall surface portion can be further suppressed.

### Details of Embodiments of Present Disclosure

### Embodiment

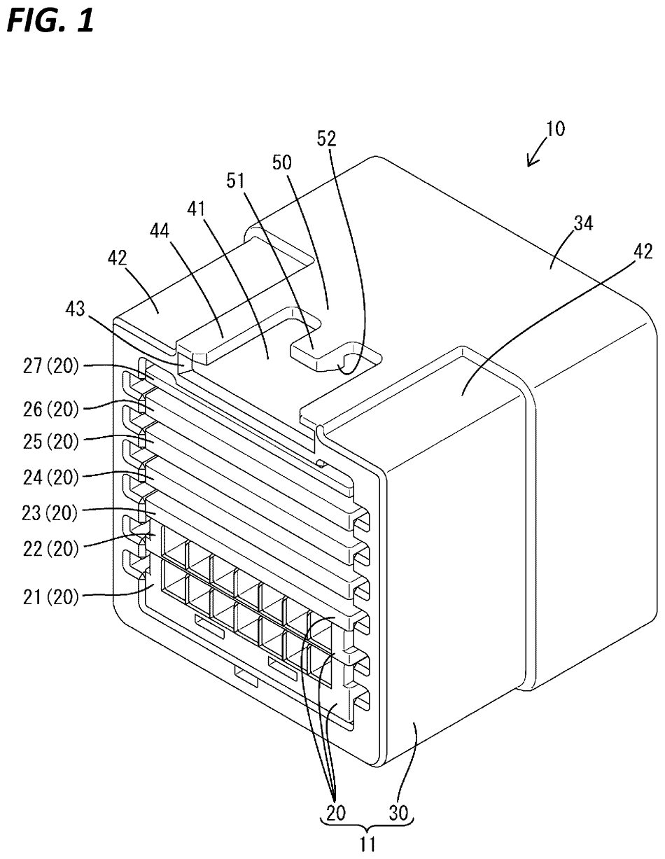

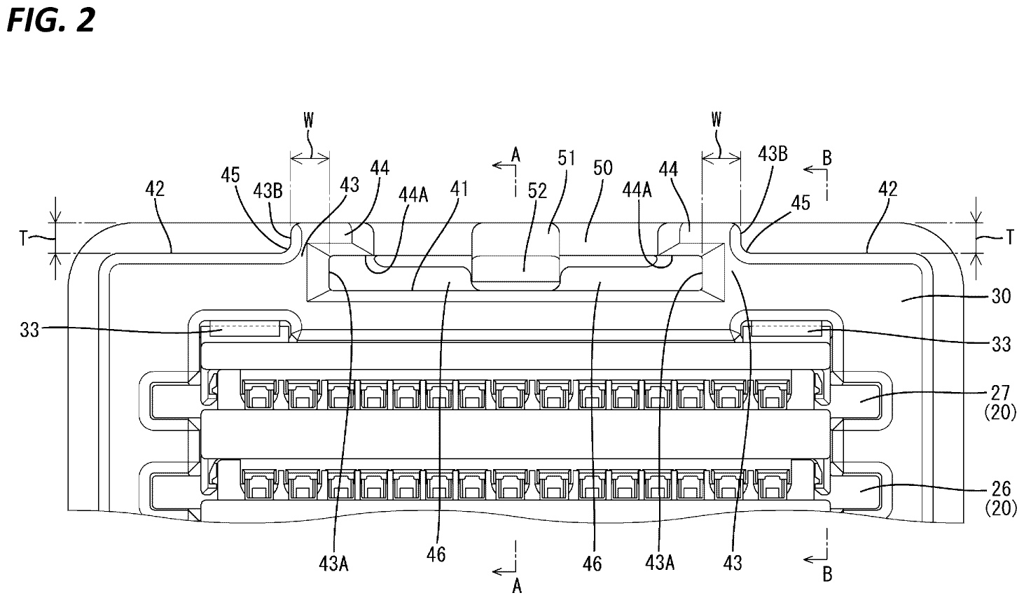

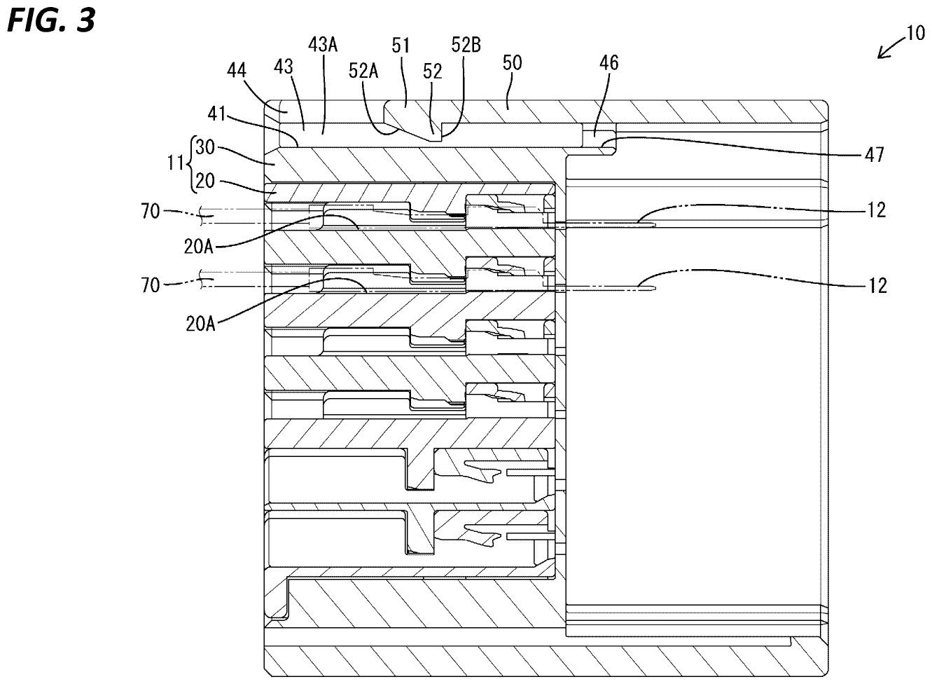

One specific embodiment of a connector of the present disclosure is described with reference to FIGS. 1 to 5. In this embodiment, right and left sides shown in FIGS. 3 to 5 are respectively defined as front and rear sides concerning a front-rear direction. Upper and lower sides shown in FIGS. 1 to 4 are directly defined as upper and lower sides concerning a vertical direction. A lateral direction of FIG. 2 is defined as a width direction.

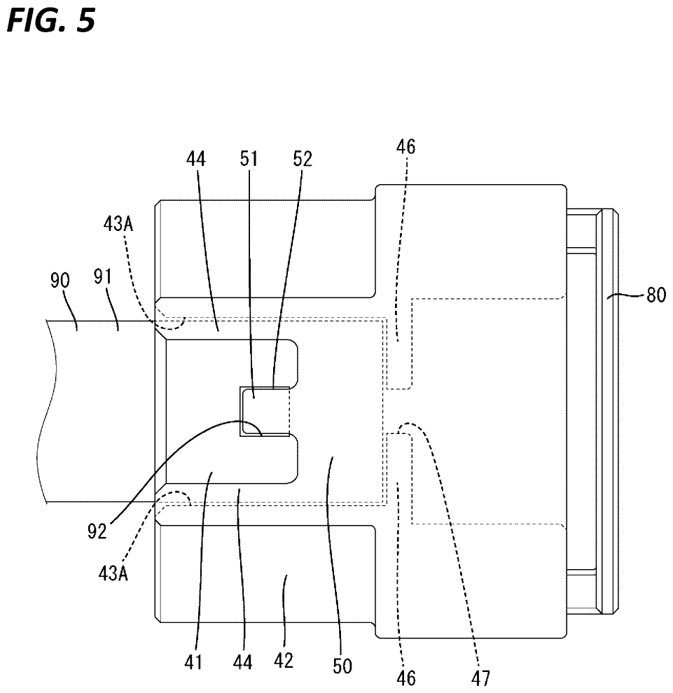

A connector 10 of the first embodiment shown in FIG. 1 is a connector of a type to be fixed to a bracket 90 (see FIG. 5). The connector 10 is provided with a housing 11 and terminal fittings 12 (see FIG. 3). The housing 11 includes sub-housings 20 and a holder 30.

The sub-housing 20 has an insulating property. The sub-housing 20 is made of synthetic resin. As shown in FIG. 3, the sub-housing 20 includes cavities 20A. The terminal fitting 12 is arranged in the cavity 20A. The terminal fitting 12 is a male terminal fitting. The terminal fitting 12 is electrically conductive. The terminal fitting 12 is, for example, formed by bending a metal plate. A wire 70 is electrically connected to a rear end side of the terminal fitting 12 by crimping. The terminal fitting 12 is inserted into the cavity 20A from behind while being connected to the wire 70.

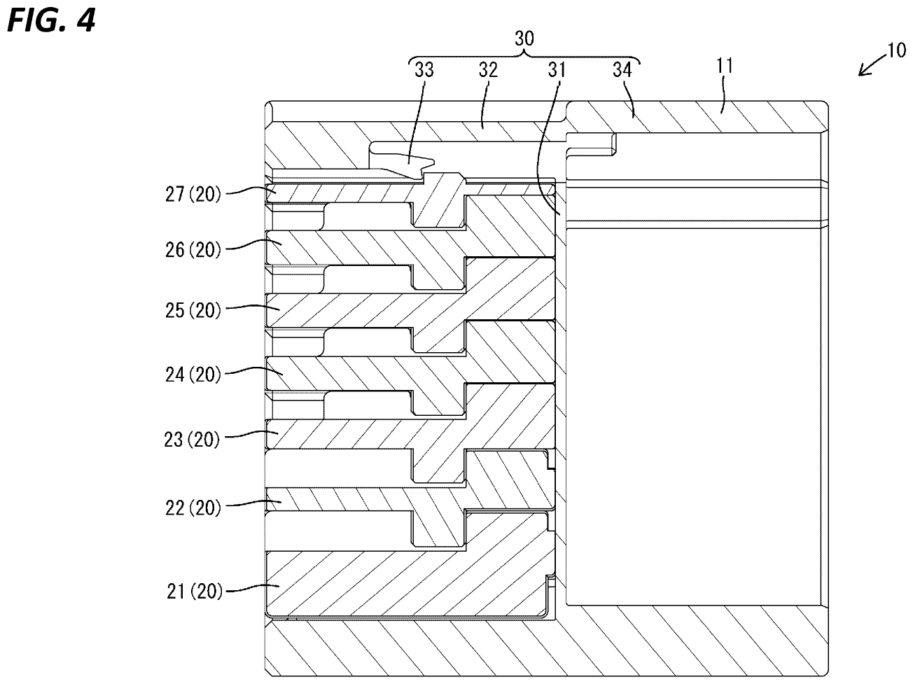

As shown in FIGS. 1 and 4, a plurality of (seven) sub-housings 20 are provided. The seven sub-housings 20 are also referred to as the sub-housings 21, 22, 23, 24, 25, 26 and 27 below. The sub-housings 21 to 27 are stacked and arranged in the vertical direction. Each of the sub-housings 21 to 27 is coupled to the vertically adjacent sub-housing(s) 20. A forward movement of the sub-housing 22 to 27 is restricted by the sub-housing 20 adjacent on a lower side. A rearward movement of the sub-housing 21 to 26 is restricted by the sub-housing 20 adjacent on an upper side. Therefore, the sub-housings 21 to 27 are fit halfway into the holder 30 after being vertically coupled to each other, and successively properly fit from the sub-housing 20 on the lowest side. The sub-housing 27 in the uppermost stage is retained by retaining portions 33 of the holder 30 to be described later. In this way, all the sub-housings 21 to 27 are retained.

The holder 30 has an insulating property. The holder 30 is made of synthetic resin. The holder 30 has a function of holding the sub-housings 21 to 27. As shown in FIG. 4, the holder 30 includes a center wall portion 31, an accommodating portion 32, the retaining portions 33 and a receptacle 34.

The center wall portion 31 has a thickness in the front-rear direction. The accommodating portion 32 is in the form of a tube (more specifically, a rectangular tube) projecting rearward from an outer peripheral part of the center wall portion 31. The accommodating portion 32 is open in the rear surface of the holder 30. The sub-housings 21 to 27 in a coupled state are fit into the accommodating portion 32 from behind.

The retaining portions 33 project into the accommodating portion 32 from the inner peripheral surface (more specifically, the ceiling surface) of the accommodating portion 32. The retaining portions 33 lock the sub-housing 27 in the uppermost stage, out of the sub-housings 21 to 27 fit into the accommodating portion 32. The retaining portions 33 are arranged in pair in the width direction (see FIG. 2). The retaining portions 33 are arranged more outward in the width direction than a pair of wall surface portions 43 to be described later. In this way, the connector 10 is reduced in height.

The receptacle 34 is in the form of a tube (more specifically, a rectangular tube) projecting forward from the outer peripheral part of the center wall portion 31. A mating connector 80 (see FIG. 5) is fit into the receptacle 34.

As shown in FIGS. 1 and 2, the holder 30 includes a first surface 41, second surfaces 42, the wall surface portions 43, projecting portions 44 and curved surfaces 45. The first surface 41 is formed on the outer peripheral surface (more specifically, the upper surface) of the holder 30 and a flat surface. The first surface 41 is formed on the upper surface of the accommodating portion 32.

The wall surface portions 43 rise from both end parts in the width direction of the first surface 41 and are arranged in pair on both sides in the width direction of the first surface 41. The pair of wall surface portions 43 are facing each other in the width direction. An inner side surface 43A of the wall surface portion 43 is a flat surface orthogonal to the first surface 41. The rising end edge of the wall surface portion 43 is arranged at the same height position as the upper surface of the receptacle 34.

The projecting portions 44 respectively project inward in the width direction from rising end parts of the pair of wall surface portions 43. The projecting portion 44 has a facing surface 44A facing the first surface 41. The facing surface 44A is the lower surface of the projecting portion 44 and parallel to the first surface 41. The upper surface of the projecting portion 44 is arranged at the same height position as the upper surface of the receptacle 34 and flush with the upper surface of the receptacle 34.

The second surfaces 42 are formed on the outer peripheral surface (more specifically, the upper surface) of the holder 30 and flat surfaces. The second surfaces 42 extend outward in the width direction from outer side surfaces 43B of the pair of wall surface portions 43. The second surface 42 is parallel to the first surface 41 and arranged at a position higher than the first surface 41. The second surface 42 is arranged at a position lower than the rising end edge of the wall surface portion 43. According to this configuration, sinks are less likely to be formed in the second surface 42 as compared to a configuration in which the second surface 42 is arranged at the same height position as the rising end edge of the wall surface portion 43. The second surface 42 is arranged at the same height position as the facing surface 44A.

A width W between the inner side surface 43A and the outer side surface 43B in the width direction of the wall surface portion 43 is larger than a difference T between the height position of the rising end edge of the wall surface portion 43 and that of the second surface 42. A lower end part of the outer side surface 43B in the width direction of the wall surface portion 43 is connected to the second surface 42 via the curved surface 45.

As shown in FIGS. 2 and 3, the holder 30 includes a back wall portion 46 and a through hole 47. The back wall portion 46 rises from a front end side (more specifically, a front end part) of the first surface 41 between the pair of wall surface portions 43. The through hole 47 penetrates through a widthwise central part of the back wall portion 46 in the front-rear direction. The through hole 47 communicates with an internal space of the receptacle 34. The back wall portion 46 is divided in the width direction by the through hole 47, and the divided parts are respectively connected to the inner side surfaces 43 A of the pair of wall surface portions 43.

As shown in FIGS. 1 and 3, the holder 30 includes a linking portion 50, an extending portion 51 and a locking portion 52. The linking portion 50 links the rising end parts of the pair of wall surface portions 43 at a position forward of the projecting portions 44. The rear end of the linking portion 50 is connected to the front ends of the pair of projecting portions 44. The front end of the linking portion 50 is connected to the rear end of the receptacle 34. According to this configuration, the entrance of an external matter between the linking portion 50 and the first surface 41 from front can be suppressed. The upper surface of the linking portion 50 is flush with the upper surface of the receptacle 34.

The extending portion 51 is cantilevered rearward from a widthwise central part of a rear end part of the linking portion 50. The extending portion 51 is arranged between the pair of projecting portions 44 in the width direction.

The locking portion 52 projects downward from an extending end part of the extending portion 51. The locking portion 52 has an inclined surface 52A and a locking surface 52B. The inclined surface 52A is so inclined that a lower end part is inclined forward. The locking surface 52B is formed on the front surface of the locking portion 52.

As shown in FIG. 5, the bracket 90 is mounted on the connector 10. The bracket 90 is, for example, made of metal. The bracket 90 includes a coupling portion 91 to be coupled to the connector 10. The coupling portion 91 is plate-like. The coupling portion 91 is formed with a locking hole 92 penetrating through the coupling portion 91 in a thickness direction. The locking hole 92 has a rectangular shape. A width of the coupling portion 91 is smaller than an interval in the width direction between the pair of wall surface portions 43 and larger than an interval in the width direction between the pair of projecting portions 44. A thickness of the coupling portion 91 is smaller than an interval between the first surface 41 and the facing surfaces 44A. The coupling portion 91 is inserted into a receiving frame constituted by the pair of wall surface portions 43 and the pair of projecting portions 44 from behind. When contacting the inclined surface 52A of the locking portion 52, the coupling portion 91 enters the receiving frame while deflecting the linking portion 50 and the coupling portion 91 upward. When the locking portion 52 is fit into the locking hole 92 of the coupling portion 91, the coupling portion 91 is locked. In this way, the bracket 90 is mounted on the connector 10.

With the bracket 90 mounted on the connector 10, an external force may be applied to the wall surface portions 43 due to vibration or the prying of the bracket 90. In this respect, as described above, the second surfaces 42 extend outward in the width direction from the outer side surfaces 43B of the pair of wall surface portions 43 in the connector 10. The second surfaces 42 are arranged at positions higher than the first surface 41. Thus, according to this configuration, the wall surface portions 43 are reinforced as compared to the configuration in which the second surfaces 42 are arranged at the same height position as the first surface 41, wherefore the deformation of the wall surface portions 43 when an external force is applied to the wall surface portions 43 can be suppressed.

Further, the projecting portion 44 has the facing surface 44A facing the first surface 41, and the second surface 42 is arranged at the position higher than the facing surface 44. According to this configuration, the wall surface portion 43 can be entirely reinforced in a rising direction at a position lower than the projecting portion 44.

Further, a width W between the inner side surface 43A and the outer side surface 43B in the width direction of the wall surface portion 43 is larger than the difference T between the height position of the rising end edge of the wall surface portion 43 and that of the second surface 42. According to this configuration, moment and stress generated in the wall surface portion 43 when the rising end side of the wall surface portion 43 (more specifically, a part of the wall surface portion 43 above the second surface 42) receives an external force acting outward in the width direction can be reduced. Thus, the deformation of the rising end side of the wall surface portion 43 (more specifically, the part of the wall surface portion 43 above the second surface 42) can be suppressed.

Further, the outer side surface 43B in the width direction of the wall surface portion 43 is connected to the second surface 42 via the curved surface 45. According to this configuration, since stress applied to the base end side of the wall surface portion 43 can be dispersed by the curved surface 45 when the rising end side of the wall surface portion 43 is deflected and deformed outward in the width direction, the deformation of the wall surface portion 43 can be further suppressed.

### Other Embodiments

The present invention is not limited to the above described and illustrated embodiment, but is represented by claims. The present invention is intended to include all changes in the scope of claims and in the meaning and scope of equivalents and also include the following embodiments.
(1) Although the second surface is arranged at the same height position as the facing surface in the above embodiment, the second surface may be arranged at a position higher than the facing surface. Also in this case, the wall surface portion can be entirely reinforced in the rising direction at the position lower than the projecting portion. Further, although the strength of the wall surface portion is reduced, the second surface may be arranged at a position lower than the facing surface.
(2) The second surface only has to be arranged at a position higher than the first surface and may be, for example, arranged at the same height position as the rising end edge of the wall surface portion.
(3) In the above embodiment, the width between the inner and outer side surfaces in the width direction of the wall surface portion is larger than the difference between the height position of the rising end edge of the wall surface portion and that of the second surface. However, the width between the inner and outer side surfaces in the width direction of the wall surface portion may be smaller than or equal to the difference between the height position of the rising end edge of the wall surface portion and that of the second surface.
(4) The curved surfaces may be not provided. That is, the outer side surface in the width direction of the wall surface portion may be directly connected to the second surface. For example, the outer side surface in the width direction of the wall surface portion may be orthogonal to the second surface.

### LIST OF REFERENCE NUMERALS

10 connector
11 housing
12 terminal fitting
20 sub-housing
20A cavity
21 sub-housing
22 sub-housing
23 sub-housing
24 sub-housing
25 sub-housing
26 sub-housing
27 sub-housing
30 holder
31 center wall portion
32 accommodating portion
33 retaining portion
34 receptacle
41 first surface
42 second surface
43 wall surface portion
43A inner side surface
43B outer side surface
44 projecting portion
44A facing surface
45 curved surface
46 back wall portion
47 through hole
50 linking portion
51 extending portion
52 locking portion
52A inclined surface
52B locking surface
70 wire
80 mating connector
90 bracket
91 coupling portion
92 locking hole
T difference between height position of rising end edge of wall surface portion and that of second surface
W width between inner and outer side surface in width direction of wall surface portion

What is claimed is:

1. A connector, comprising a housing,
the housing including:
a receptable open forward;
a flat first surface formed on an outer peripheral surface of the housing;
a pair of wall surface portions rising from both end parts in a width direction of the first surface;
a pair of projecting portions projecting inward in the width direction from rising end parts of the pair of wall surface portions;
second surfaces formed on the outer peripheral surface, the second surfaces extending toward sides opposite to the projecting portions from the pair of wall surface portions; and
a linking portion coupling rising end parts of the pair of wall surface portions,
a front end of the linking portion being connected to a rear end of the receptacle, and
the second surface being arranged at a position higher than the first surface.

2. The connector of claim 1, wherein the second surface is arranged at a position lower than a rising end edge of the wall surface portion.

3. The connector of claim 2, wherein:
the projecting portion has a facing surface facing the first surface, and
the second surface is arranged at the same height position as the facing surface or at a position higher than the facing surface.

4. The connector of claim 2 or 3, wherein a width between an inner side surface and an outer side surface in the width direction of the wall surface portion is larger than a difference between the height position of the rising end edge of the wall surface portion and that of the second surface.

5. The connector of any one of claims 2 to 4, wherein an outer side surface in the width direction of the wall surface portion is connected to the second surface via a curved surface.
